(19) United States
(12) Patent Application Publication
(10) Pub. No.: US 2017/0007960 A1
(43) Pub. Date: Jan. 12, 2017

(54) FILLERS FOR TREATING FLUE-GAS AND APPARATUS FOR TREATING FLUE-GAS FILLED WITH THE FILLERS

(71) Applicants: Takeshi KIMURA, Ibaraki (JP); Noriko KIMURA, Tokyo (JP); Junko SATO, Tokyo (JP); Shigeru KIMURA, Tokyo (JP)

(72) Inventor: Takeshi KIMURA, Ibaraki (JP)

(21) Appl. No.: 14/791,791

(22) Filed: Jul. 6, 2015

(51) Int. Cl. B01D 53/50; B01D 53/81

(52) U.S. Cl. CPC B01D 53/508; B01D 53/81; B01D 2251/404

(57) ABSTRACT

The present invention relates to fillers for flue-gas treatment comprising by preparing two kinds of large and small fillers with different diameters of cylinder bodies each of which comprising by plurally providing circular windows having hole diameter from one third to two thirds of diameter of a thin-walled cylinder body on a cylinder wall of the thin-walled cylinder body that the diameter and the length thereof are approximately equal in a circumferential direction of the thin-walled cylinder body, wherein the smaller filler (hereinafter, saying “the small filler”) is installed in an inner diameter side of the larger filler (hereinafter, saying “the large filler”) and the small filler is supported loosely in a suspended state to the cylinder body o the large filler by a suspending retainer, so that the small filler is constituted movably along an inner surface of the cylinder body of the large filler. Thus, inner surfaces and outer surfaces of the large fillers and the small fillers are automatically cleaned, so that scaling adhesion of the rotating packed bed can be disappeared.

### TECHNICAL FIELD

The present invention relates to fillers that are used in apparatuses for flue-gas desulfurization for removing sulfurous acid gas exhausted from factories, power plants, waste incinerator plants, or the like, or for recovering carbon dioxide gas, for promoting gas-liquid contact efficiently, and to an apparatus for treating flue-gas comprising of filling the fillers.

### BACKGROUND OF THE INVENTION

As a means for removing substance causing air pollution from flue-gas or combustion flue-gas containing sulfurous acid gas exhausted from factories or power plants recently, for instance, a finishing flue-gas desulfurization apparatus providing with a wet type electrical dust collecting unit removing soot and dust in the flue-gas in the downstream side of a finishing desulfurization unit of a desulfurization equipment main body installing a gas introducing unit and the finishing desulfurization unit for desulfurizing by contacting absorbing liquid to the introduced gas and an flue-gas cooling unit and an flue-gas treatment system using the finishing flue-gas desulfurization facility are known (JP 2011-177674A).

Besides, in a flue-gas desulfurization apparatus providing with a spray header having a plurality of spray nozzles for spraying absorbing liquid to flue-gas and an absorbing tower installing a mist eliminator in the downstream side thereof to absorb and remove sulfur oxides in the flue-gas, a wet type flue-gas desulfurization apparatus so that a spray header for dust removal that has a plurality of two fluid spray nozzles that make smaller fine droplet than the spray nozzles of the spray header and that spray counter currently against the flue-gas flow is provided between the above-mentioned spray header and the mist eliminator is also known (JP 2013-6125 A).

Furthermore, a wet type flue-gas desulfurization apparatus that is provided with a gas cooler used with refrigerant, a flow regulating valve for controlling flow rate of refrigerant supplied to the gas cooler, a thermometer for measuring temperature of treated gas passing through the gas cooler, a control unit for controlling flow rate of refrigerant based on the measured value of the thermometer, and a means for collecting condensed water b cooling the treated gas by the gas cooler and condensing moisture in the treated gas is also known (JP 2013-39527 A).

Moreover, in a desulfurization apparatus that is provided with a spray header having spray nozzles spraying absorbing liquid to flue-gas, a bottom tank for storing the absorbing liquid sprayed from the spray nozzles, an absorbing tower with piping for circulating the absorbing liquid in the tank to the spray nozzles, an intake duct for introducing the flue-gas into the absorbing tower main body, and an outlet duct provided on the upper end thereof, a flue-gas desulfurization apparatus that is provided with a plurality of flat nozzles which spray the absorbing liquid toward the inside of the absorbing tower and each of which has a flat surface in a countercurrent direction to the sprayed absorbing liquid from the spray nozzles from which the spray shape is fallen down is also known (JP 2013-158765 A). And further, a desulfurization apparatus for harmful gas such that fillers for gas-liquid contact are filled in a cage type rotating cylinder body in order to make contacting the flue-gas and the absorbing liquid more efficiently in the rotating cylinder by the present inventors is also known (JP 4418987 B and JP 2013-237017 A).

### PATENT DOCUMENTS

[Patent Document 1] JP 2011-177674 A

[Patent Document 2] JP 2013-6125 A

[Patent Document 3] JP 2013-39527 A

[Patent Document 4] JP 2013-158765 A

[Patent Document 5] JP 4418987

[Patent Document 6] JP 2013-237017 A

[Patent Document 7] JP 4505041

### SUMMARY OF THE INVENTION

The apparatuses disclosed in the above-mentioned patent documents Nos. 1 to 4 are to have constitution such that flue-gas flows vertically. Prior many flue-gas treatment apparatus not just for the apparatuses disclosed in the above patent documents have been adopted with a system that the flue-gas flows vertically. The reason was in a point that the system to flow the flue-gas vertically is easier to make experiment. However, as considering physically, in the case of the system to flow the flue-gas vertically, when the flue-gas flows vertically using a cylinder with diameter D, a volume of the treatment fluid necessary to be circulated is proportional to the above mentioned D². For this, in the case of flowing the flue-gas horizontally, the volume of the treatment fluid to be circulated is to be proportional to the above mentioned D.

That is to say, area of the absorbing liquid dispersion part in the case of the flue-gas treatment system with 30 m in diameter is:
an flue-gas absorbing tower (vertical gas flow) π/4×30×30=706.5 m²
an flue-gas absorbing apparatus (horizontal gas flow) 30×3=90 m²
(requiring about 3 m in length in the case of the flue-gas desulfurization has already been known due to embodiments and experiments described in the patent documents 6 and 7 by the present inventor).

Therefore, rate between both areas is 706.5/90≈7.85.

As absorbing liquid dispersion in the ease of the flue-gas absorbing tower is a spray system, if the spray amount thereof is 100 m³/m²h, and, if the spray amount thereof is 50 m³/m²h as it is a packed bed in case of the rotating packed bed, the total treatment liquid amount of each case is:

100×706.5=70,650 m³/h in the flue-gas absorbing tower, and

50×90=4,500 m³/h in the case of flowing the flue-gas horizontally,

so that the rate between both amounts is 70,650/4,500≈115.7.

Accordingly, since diameter D of the flue-gas treatment apparatus also comes to be large necessarily with especially recent flue-gas desulfurization or collection of carbon dioxide gas growing in size, it is understood that horizontal direction for the flue-gas flowing direction is advantageous obviously. Based on thus knowledge, the present inventor has gotten to develop inventions described in the above-mentioned patent documents 5 and 6. In the case of the flue-gas desulfurization system by a lime stone-gypsum method disclosed in the patent documents 5 and 6, the length thereof requires only about 3 m. Next, considering about pressure-loss between the case of the vertical direction and the case of the horizontal direction of the flue-gas flow in the treatment apparatus, when the flue-gas flow is made vertical, namely for instance, when the absorbing liquid flows downward and the flue-gas flows upward, the draft pressure-loss is large because the flow of the absorbing liquid is resistance against the flue-gas flow.

In contrast, when the flue-gas flow is made horizontal, it is little that the absorbing liquid flow inhibits the flue-gas flow.

That is to say, relationship of pressure-loss in this case is that

the case that the flue-gas flow is vertical>the case that the flue-gas flow is horizontal,

as the result, about the exhaust fan power of the flue-gas draft, it is found that the case of the horizontal flue-gas flow is less and advantageous. It is also possible to increasing absorbing efficiency of the absorbing liquid by arranging macro flow of the absorbing liquid on series multistage.

From the above, it has been understood that the vertical direction system in the flue-gas absorbing tower in small size flue-gas treatment apparatus with not more than 3.8 m in diameter is more advantageous, but the horizontal direction system in the treatment apparatus with more than 3.8 m in diameter.

On the other hand, about chemical reaction process in flue-gas desulfurization in the limestone-gypsum method is thought as follows:

SO₂+H₂O [symbol] H₂SO₃ (1)

CaCO₃ [symbol] Ca²⁺+CO₃²⁻ (2)

Ca²⁺+H₂SO₃ [symbol] CaSO₃+2H⁺ (3)

CaSO₃+½O₂+2H₂O→CaSO₄.2H₂O (4)

Seeing page 153 (page 515) in Solution Chemistry Section of Chronological Scientific Tables in order to consider the speed of the above reaction, tables indicating, “Solubility of Gas to Water” and “Solubility Product of Hardly-Soluble Salt” are displayed there, it is found that solubility of sulfurous acid gas to water is anger next to hydrogen chloride.

Seeing about calcium carbonate there, it is classified as a hardly-soluble salt and the solubility product thereof is indicated as 3.6×10⁻⁹. The reaction speed is fast because the above-mentioned chemical reaction process (3) is reaction between base and acid.

Accordingly, the reactions indicated as (1) to (3) can be thought as reactions for dissolving limestone particles with sulfurous acid.

And in this case, as understood also from the already-described explanation for the chemical reaction processes, the rotating packed bed would also be a stirring bath lot limestone particle solution. In this case, the larger an apparatus size is, the larger the diameter of the stirring bath is, the larger the fall height of the absorbing liquid is and the more the fall velocity is as the result, the more the stirring effect is. That is to say, it is understood that, the larger the diameter of the rotating packed bed, the more a chemical reaction amount with a single fall of the absorbing liquid is increased.

Next, considering about collection of carbon dioxide gas, to use organic amities and potassium carbonate as an absorbent and a process for recycling the absorbent are included there. Accordingly, it is desired that the absorbent transferred to a recycling treatment process is what the role of the absorbent has been finished by absorbing carbon dioxide gas efficiently. Because, to supply the absorbent that the reaction function has not be exerted to the recycling process is that the heat energy for recycling is consumed away in vain. Besides, since solubility of CO₂ to water as compared with SO₂ is low, as described above, it is advantageous that flow of the flue-gas is made to the horizontal direction and flow of the absorbent is made to a series multistage absorption system in order to increase reaction efficiency of the absorbent.

On the other hand, regarding fillers for treating exhaust gas to promoting gas-liquid contact in the flue-gas treatment apparatus, the most important thing is predicated on being at low costs and feasible as compared to fillers with a wide variety of complex constitution from what is described in the above-described patent document 5. Furthermore, it is necessary that the gas-liquid contact area is as large as possible and pressure-loss of the draft is as small as possible. All of the past fillers with a wide variety of the complex constitution are only based on the attitude such that the gas-liquid contact is increased, what is considered the mechanical strength and provision for prevention of scaling (adhesion of gypsum), and the decrease of the production costs is few.

And so, the present inventor developed gas-liquid contact fillers having constitution such that it is certain that gas-liquid contact area is secured largely, in addition to increase durability provided with crashproof adding to the fillers, abrasion quantity and load bearing by accumulating highly, that it is difficult to be adhered with the scaling or it is easy to remove it even if being adhered, or as a flue-gas desulfurization apparatus or a carbon dioxide adsorption apparatus or as a part of a power generating equipment and constitution that can be endured to a long stable use and furthermore that can be available at low costs as compared with the conventional products. The inventor developed a flue-gas treatment apparatus that is filled with said gas-liquid contact fillers.

Accordingly, in the fillers of the present invention, because the length of a rotation packed bed is comparatively short, there is no trouble even if what the length of the rotation packed bed is 3 m becomes the degree from 3 m to 4 m. As a quantity of decrease of surface area of the fillets was sacrificed, the inventor developed with emphasis on firstly that draft pressure-loss of the flue-gas was made as smaller as possible, secondly that the mechanical strength was superior and the durability is not impaired, thirdly that the area of the cylindrical inner surface easy to be scaled was made decreased, and fourthly that material weight per one piece of the fillers was made decreased largely.

In this case, the present inventor tries to use pole rings with 75 mmφ×75 mmφ in the experiment device with 1 mφ, and to use net rings whose wire diameter is made thicker by custom-order in the experiment devices with 3.2 mφ and 4.5 mφ, but, for instance, there remained the question such that they could correspond to a large capacity flue-gas desulfurization apparatus with 3,000,000 Nm³/h whose diameter is a degree from 25 m to 30 m.

Besides, among the gas-liquid contact fillers known at the moment, what the mechanical strength is the highest and the constitution is simple is raschig rings. There is also an example such that ceramics, high-molecular materials or the like with good corrosion resistance is used in the raschig rings which are fillers filled in a filling tower. Inside the filling tower, the liquid flows down along the surface of the fillers and the gas rises up gaps among the fillers to perform the gas-liquid contact. Therefore, the inventor developed fillers for flue-gas treatment according to the present invention and as flue-gas treatment apparatus filled with the fillers so as to enable flue-gas desulfurization or absorption of carbon dioxide gas more surely in the above-mentioned large capacity flue-gas treatment desulfurization apparatus based on the raschig rings with high mechanical strength.

This is to say, in the case of filling and using the above-mentioned raschig rings in the rotation packed bed, though the fillers can be rotated by random filling individual fillers (raschig rings) arc changing the directions momentarily against the gas flow direction. In this case, the gas flows easily when the cylindrical axis direction of the filler coincides with the gas flow direction, and the gas flows difficultly when the cylindrical axis direction of the filler intersects with the gas flow direction. As the result, there is a fault such that the pressure-loss of the gas flow as a whole of the rotation packed bed. Therefore, improving this point in the present invention, the fillers for gas-liquid contact that the gas pressure-loss in the rotation packed bed is decreased remarkably and that the surface area in the inner surface of the cylinder is made little small in order to decrease the scaling adhesion and that is at low costs is developed.

A first invention relates to fillers for flue-gas treatment that circular windows with hole diameter from one third to two thirds or diameter of a cylinder body are plurally provided on a cylinder wall of the thin walled cylinder body (thickness-is less than 3 mm) in a circumferential direction thereof. The invention relates to as flue-gas treatment apparatus that fillers for flue-gas treatment are plurally filled in a gas horizontal flow system of a rotating treatment device, wherein fillers for flue-gas treatment that windows with hole diameters from one third to two thirds of diameter of a cylinder body are plurally provided on a cylinder all of the thin-walled cylinder body (thickness is less than 3 mm) in a circumferential direction.

Besides, a second invention relates to fillers for flue-gas treatment, in order to increase function of the fillers of the above-mentioned first invention, that two kinds of large and small fillers with different diameters of the cylinder bodies comprising the same constitution as the fillers according to the first invention are prepared, that the smaller filler (hereinafter saying “a small filler”) is installed inside the diameter of the larger filler (hereinafter saying “a large filler”) and that the small filler is supported in a state of suspending the small filler from the cylinder body of the large filler by a suspending retainer. The invention also relates to a flue-gas treatment apparatus that fillers for flue-gas treatment comprising two kinds of large and small fillers are combined are filled plurally in the gas horizontal flow type of the rotating treatment device.

According to the fillers for flue-gas treatment of the first invention, since the windows with the hole diameters of one third or two thirds of diameters of cylinder bodies are provided plurally in a circumference direction, in the gas horizontal flow system of the rotating treatment device, even if the gas flow is intersected with an axial direction of both opening portions of the filler, because it is possible for gas flow to pass also from the plural windows formed on the cylinder wall, so that pressure-loss of the flue-gas flow is decreased extremely and efficiency of the flue-gas treatment is increased remarkably. Besides, because as cylinder inner area is decreased b forming the circular windows on the cylinder wall surface of the thin-walled cylinder body, thereby adhesion of the sealing is decreased and, the maintenance is increased and the constitution is simple, so that the costs can be decreased remarkably.

Furthermore, since the plural fillers for flue-gas treatment comprising the above constitution are filled in the gas horizontal flow system of the rotating treatment device, gas pressure-loss is decreased remarkably, so that the flue-gas treatment efficiency can be increased.

According to the fillers for flue-gas treatment of the second invention, as result of that the small filler suspended in the cylinder body of the large filler at using moves around along the inner surface of the cylinder body of the large filler, cleaning of the inner surface of the cylinder of the large filler can be promoted, and gas-liquid contact area decreased in the first invention can be increased. At the same time, since the suspending retainer slides along the inner surface of the cylinder body of the small filler, the inner surface of the small filler can be cleaned automatically, and durability of the small and large fillers can be increased largely.

### BRIEF DESCRIPTION OF DRAWING

FIG. 1 is a perspective view of the fillers for flue-gas treatment according to a working example of the first invention;

FIG. 2 is a cross-sectional view of the fillers for flue-gas treatment according to a working example of the second invention;

FIG. 3 is a longitudinal sectional view of a main section showing an outline of the gas horizontal flow system of the flue-gas treatment apparatus in the condition of installing the fillers for flue-gas treatment of the invention in the rotation packed bed; and

FIG. 4 is a cross-sectional view along the line A-A in FIG. 3.

### DETAILED DESCRIPTION OF THE INVENTION

(Constitution of the Fillers for Flue-Gas Treatment)

Hereinafter, an embodiment mode of fillers for flue-gas treatment 11 according to the first invention is explained.

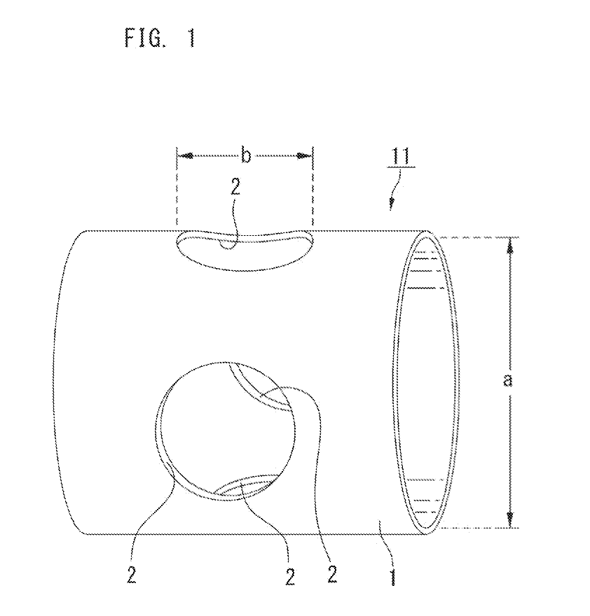

The fillers for flue-gas treatment 11 according to the present invention comprises, as shown in FIG. 1, providing plural circular windows 2 with hole diameter that is one third to two thirds of opening diameter as of a cylinder body 1 on as thin-walled cylinder body 1 in a circumferential direction of the cylinder body 1. Note that the four windows 2 are formed in the circumferential direction of the cylinder wall in the working example in FIG. 1. In the diameter of the windows 2 of this case, if the diameter is made not more than one third of the opening diameter a, because the flow resistance of the flue-gas is increased and the pressure-loss is increased, the diameter thereof cannot be decreased. Besides, to the contrary, if the diameter of the window 2 is over two thirds of the opening diameter a, as the pressure-loss is further decreased and the strength of the filler for flue-gas treatment 14 is decreased, it has been clear from the result of the experiment that to make the diameter of the window 2 by two thirds of the opening diameter a is as limiting point.

Besides, about a material of the cylinder body 1 constituting the thin-walled cylinder body (thickness is less than 3 mm), use of plastic or graphite is desired, but is not limited thereto, and use of the other metal material, ceramics, hard rubber, or Teflon® or Teflon® coating or the like is also possible. The cylinder body 1 constituting the thin-walled cylinder is used with plastic material with 90 mmφ×90 mm (cylinder length)×3 mm (wall thickness), the four windows 2 with 40 mmφ are formed at regular intervals in the circumferential direction of the cylinder body 1 on the cylinder wall thereof. When the plural cylinder bodies 1 were installed in the rotation packed bed of the gas horizontal flow system of the flue-gas treatment device and the experiment was tried, pressure-loss of the flue-gas was low and contact efficiency to the absorption liquid was extremely good.

Furthermore, about the size of the window 2 formed on the cylinder wall of the cylinder body 1, the pressure-loss of the flue-gas is high when the diameter of window 2 is less than one third of the diameter of the cylinder body 1, and to the contrary, enough strength as a thin-walled cylinder body cannot be held when the diameter at the window 2 is over two-thirds of the diameter of cylinder body 1. Accordingly, it has been clear from the result of the experiment that the size of the window 2 in this case is hole diameter from one third to two thirds of the diameter of the cylinder body 1 is necessary.

Furthermore, in the case of being the flue-gas treatment device comprising by filling the plural fillers for flue-gas treatment providing the plural above-mentioned windows 2 in the circumferential direction of the cylinder body 1 in the gas horizontal flow system of the rotating treatment device, pressure-loss of the flue-gas is little and the gas-liquid contact is performed efficiently, so that an ideal flue-gas treatment is performed.

(Constitution of the Flue-Gas Treatment Device)

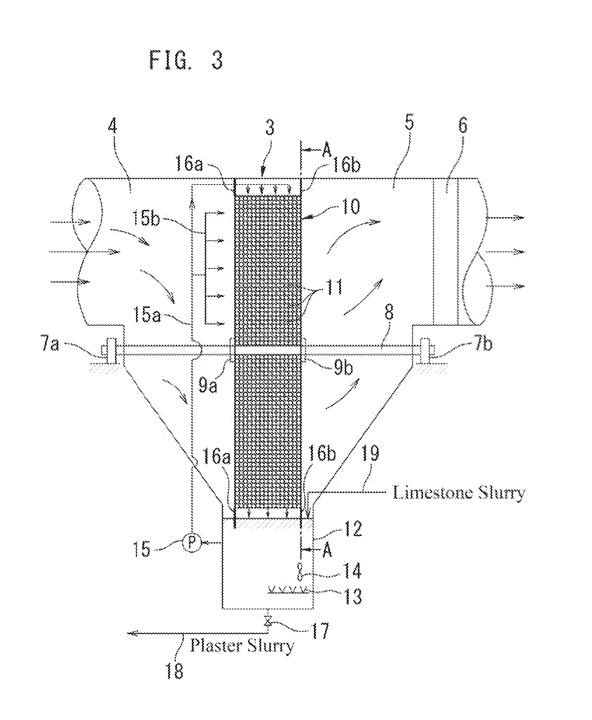

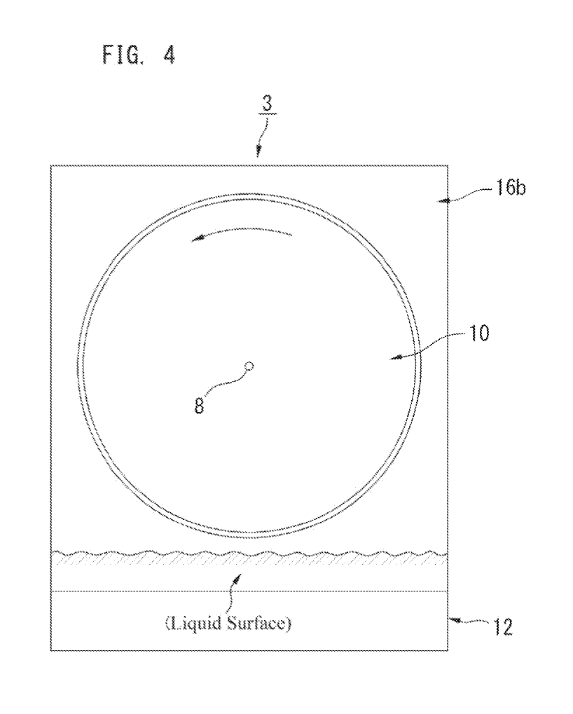

Explanation is performed on the basis of the case of applying one example of the flue-gas desulfurization apparatus installing the fillers for the flue-gas treatment 11 in the present invention to the flue-gas desulfurization apparatus by the limestone-gypsum method as shown in FIGS. 3 and 4. One example of a noxious gas desulfurization apparatus is shown in FIG. 3, wherein 3 indicates a fixed duct, 10 indicates a cage type rotating cylinder body, 11 indicates a gas-liquid contact fillers (hereinafter the same as “fillers for flue-gas treatment”) comprising the above mentioned thin-walled cylinder body 1 and installed in the cage type rotating cylinder body 10, 12 indicates a slurry storage tank formed at a lower side a the cage type rotating cylinder body 10, and 15 indicates a slurry circulating pump that draws slurry in the slurry storage tank 12 and refluxing the slurry from upside of the cage type rotating cylinder body 10 along the side outer peripheral surface. Furthermore, the fixed duct 3 has constant length horizontally as shown in FIG. 3, one end of the fixed duct 3 is provided with a gas introduction opening 4 and the other end of the fixed duct 3 is provided with a gas exhaust opening 5, and an inner space in which the cage type rotating cylinder body is installed inside thereof is formed by expanding approximately center part below, forward and backward.

Furthermore, since the cage type rotating cylinder body 10 is filled in a random state with plural fillers that is about the size of 90φ×length:90 mm×thickness:3 mm, a circumferential surface thereof are formed in a lattice shape at intervals from about 80 to about 85 mm. The cage type rotating cylinder body 10 is supported rotatably by a pair of bosses 7a, 7b around a horizontal shaft 8 in the fixed duct 3 so as to thee one of side surfaces to the gas introduction opening 4 and another side of side surfaces to the gas exhaust opening 5, and the right and left side surfaces thereof are formed in a lattice shape at intervals (from about 80 to about 85 mm) through which the gas-liquid contact fillers 11 installed inside thereof leave. Furthermore, the cage type rotating cylinder body 10 is that, in the ease that the diameter is large, seeing from the gas exhaust direction side of the fixed duct 3, the inner space of the rotating cylinder body 10 is divided to plural spaces around the above-mentioned horizontal shaft 8 by a small size diameter cylinder, a middle size diameter cylinder with larger diameter than one of the small size diameter cylinder, and radiated dividing walls (not shown in the figure), bias of the gas-liquid contact fillers 11 installed inside that is prone corresponding to rotation of the cage type rotating cylinder body 10 can be prevented to be able to position them evenly, so that desulfurization efficiency can be even more increased.

Besides, the horizontal shaft 8 supporting the cage type rotating cylinder body 10 is supported so that one end of it is supported on the gas introduction opening 4 via a bearing 9a and another end of it is supported on the gas exhaust opening 5 via a bearing 9b. The gas-liquid contact filler 11 is constituted, as described above, so as to be able to be rotated in the cage type rotating cylinder body 10 as shown in FIG. 1. Furthermore, the slurry storage tank 12 is installed on a bottom part of the above-mentioned fixed duct 3 and is formed by being positioned at a lower part of the cage type rotating cylinder body 10. Note that 13 indicates an air-blowing device, 14 indicates a slurring device, and 16a and 16b indicate gas sealing plates. Piping 18 for taking gypsum out via a valve 17 is connected with the bottom part of the slurry storage tank 12. Limestone powder slurry is used as slurry stored in the slurry storage tank 12 in this case, and is supplied via gypsum slurry supplying piping 19 to the slurry storage tank 12.

A slurry circulation pump 15 draws slurry in the slurry storage tank 12 and sprays it to an upside outer periphery and a side surface of the cage type rotating cylinder body 10. In this case, the slurry drawn from the slurry storage tank 12 by the drawing pump 15 (P) is sprayed via pipes 15a, 15b to the upside outer periphery and the side surface part at one side in the circumferential direction based on the horizontal shaft 8 of the cage type rotating cylinder body 10, but rotation speed of the cage type rotating cylinder body 10 is controlled by using bias of a slurry weight balance by availably adjusting bias toward one side of the circumferential direction based on the horizontal shaft 8 of the cage type rotating cylinder body 10.

(Function Effect of the Flue-Gas Treatment Device)

In constitution of the flue-gas desulfurization device due to the above-mentioned limestone-gypsum method, limestone powder slurry is supplied is as limestone slurry supplying pipe 19 into the slurry storage tank 12 continually. While the supplied slurry is air-purged by the air-blowing device 13 in the shiny storage tank 12 and always stirred by the stirring device 14 to enrich oxygen sufficiently, and is drawn by the pump P on the pipe 15 that is a slurry circulation means via the pipes 15a and 15b to be dispersed and irrigated in the cage type rotating cylinder body 10.

Besides, this dispersion irrigating liquid does not always need a spray nozzle, but may be flown down only from the end of the supplying pipe. In this case, the cage type rotating cylinder body 10 filled with fillers such as gas-liquid contacting fillers 11 can be rotated by a little torque since it is symmetric rotatable around the horizontal shaft 8. Accordingly, since the dispersion irrigating liquid to the cage type rotating cylinder body 10 is sprayed to the upside outer periphery and the side surface part at one side of the circumferential direction based on the horizontal shaft 8 of the cage type rotating cylinder body 10 and is circulated in large quantity, the cage type rotating cylinder body 10 can start rotating due to the principle of a waterwheel.

Accordingly, since slurry quantity flowing down on one semicircle part of the cage type rotating cylinder body 10 located at a forward direction of the rotation is more than slurry quantity flowing down on another semicircle part of the cage type rotating cylinder body 10 located at a backward direction of the rotation, torque proportional to the weight also works, as the result, the cage type rotating cylinder body 10 can keep rotation continuously.

On the other hand, required rotation speed of the cage type rotating cylinder body 10 suffices to be about 3 rpm because gas passing through the fixed duct 3 is made gas-liquid contact enough against the slurry when the gas passes through the cage type rotating cylinder body 10. In this case, when the rotation speed underruns 1 rpm, the gas-liquid contact tends to be insufficient. Besides, to the contrary, even if the rotation speed exceeds 7 rpm, the effect is almost invariable. Accordingly, it is ideal that the rotation speed is in a range from 1 to 7 rpm.

Thus required rotation speed of the cage type rotating cylinder body 10 can be adjusted easily by controlling pumpage rate of slurry by the pump P of the slurry circulating means 15, and by installing buckets or pressure plates for positive rotation or for negative rotation on the outer periphery of the cage type rotating cylinder body 10 and by controlling flow quantity of slurry to each of the buckets or the pressure plates, the required rotation speed can be adjusted easily. The noxious gas is introduced from the gas introduction opening 4 into the fixed duct 3 by a blower not shown in the figure, passes through the middle cage type rotating cylinder body 10 to the as exhaust opening 5 and exhausts via a mist separator 6.

On the other hand, the slurry circulated in the cage type rotating cylinder body 10 flows down on the surfaces such as gas-liquid contact fillers 11 with receiving influence of gravity of slurry flowing down in the cage type rotating cylinder body 10 and rotation of the cage type muting cylinder body 10 itself, slurry liquid film formed at that time flows down in the storage tank 12 with reacting by the gas-liquid contact in a large area with the gas passing through the fixed duct 3. The slurry flowing down in the storage tank 12 includes a quantity of the gypsum by the gas-liquid contact with the gas. The air purging is performed h the air blowing device 13 with stirring by the stirring device 14 in the storage tank 12, and the slurry is circulated serially with dissolving limestone powder while the fresh oxygen is resupplied.

In the case due to the above constitution, since the fillers 11 is filled randomly in the cage type rotating cylinder body 10 and the plural windows 2 are formed on the respective peripheral walls in the respective fillers 11, in the case that the flow direction of the flue-gas and a cylindrical shaft direction of the filler 11 intersect, draft pressure-loss of the flue-gas is decreased and exhaust fan power is also decreased. Besides, regarding the filler 11, the mechanical strength of it can be increased by increasing wall thickness of it or enlarging the cylinder diameter of it.

In a gas-liquid contact reaction process in the apparatuses shown in FIGS. 3 and 4 as described above, since solution of limestone particles is a rate controlling step, by forming the windows 2 on the peripheral wall of the filler 11, even if the surface area thereof is decreased, absorption function of the flue-gas is hard to be decreased.

(The Case of Using the Carbon Dioxide Absorption Apparatus)

Since an apparatus for carbon dioxide absorption is a large-sized apparatus, the packed bed grows in height, but the fillers 11 in the present working example has a mechanical strength that is tolerable enough to use to them. Besides, in this case, by that the cylinder shaft direction of the inventive filler 11 is oriented to the flow direction of the flue-gas and that commercial fillers that is inferior in mechanical strength but the surface area thereof is large are filled inside the cylinder body 1 separately, both functions can be exerted efficiently at low cost. Furthermore, in this case, since a series multistage method can be adopted in falling of the absorption liquid, CO₂ whose solubility to water is low can be absorbed efficiently.

Furthermore, about the absorption of CO₂, it is different from the case of the flue-gas desulfurization, and the absorbed amount of the gas is extremely-numerous.

Incidentally, since the absorbed amount of SO₂ is about 1,000 ppm, that is about 0.1%, whereas the absorbed amount of CO₂ is from to 10%, if the absorbed amount of CO₂ is 5%, the absorbed amount of CO₂ is to be 5/0.1=50 times of the case of SO₂.

Thus, in the absorption of CO₂, there is possibility such that the length of the packed bed is increased, and in this case, it can be thought that the fillers according to the present invention with feature such that the pressure-loss is little can be worked more efficiently. Furthermore, as reaction amount is extremely-numerous, according to any sorts of absorption agents, in order to prevent the increase of the temperature by generation or the reaction heat, the invention that a heat exchanger is installed in the fixed packed bed has also been performed (seeing the patent document 7).

As described above, since the flue-gas desulfurization apparatus and the carbon dioxide gas absorption apparatus can share the fillers according to the present invention by only changing a filling manner, the cost reduction for this aspect is attained and it is extremely significant for a global environmental conservation. Besides, in the case of using the fillers for flue-gas treatment 11 of the first invention, as the flow of the flue-gas is horizontal in either the flue-gas desulfurization apparatus or the carbon dioxide gas absorption apparatus, it is possible to unify them as one device and it is possible to simplify constitution of equipment considerably.

(The Second Invention)

The other working embodiment of the fillers for flue-gas treatment 11 of the above first invention is proposed as the second invention as follows.

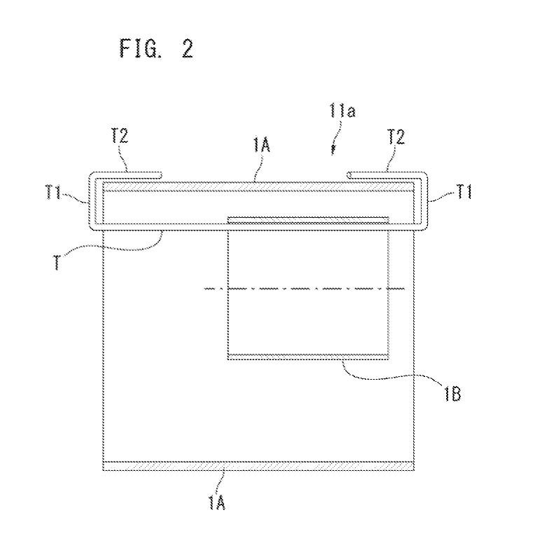

In FIG. 2, the constitution of the fillers for flue-gas treatment 11a according to the second invention is shown in section. The fillers for flue-gas treatment 11a according to the second invention, in order to increase function of the fillers according to the above first invention furthermore, as shown in section in FIG. 2, comprises by preparing small and large fillers with different cylinder diameters consisting of the same constitution as the fillers according to the first invention, installing smaller fillers (hereinafter saying “small fillers”) 1B into inner diameter sides of larger fillers (hereinafter saying “large fillers”) 1A respectively, and supporting the small fillers 1B to cylinder inner diameter sides of the large fillers 1A by suspending retainers in loose suspending conditions, respectively.

The suspending retainer T is formed with stainless wire in this case and constituted by following a middle part thereof elongated in some degree more than axial length of the large filler 1A along the inner diameter wall surface of the small filler 1B, forming standing-up parts T1 and T1 by bending the left and right end parts thereof at rights and rising them up at the end parts of the large filler 1A to outer periphery directions of the large filler 1A, facing both ends of engaging parts T2 and T2 to butted directions by bending the end parts of the standing-up parts T1 and T1 at rights so as to become parallel to inner diameter parts of the small filler 1B of the suspending retainer T so as to follow along the outer periphery surface of the large filler 1A, and retaining the small filler 1B to the large filler 1A loosely.

Besides, it is also possible to use by filling the plural fillers for flue-gas treatment that the above small filler 1B is retained loosely to the large filler 1A and that comprises by combining large and small fillers as shown in FIG. 2 in the gas horizontal flow system of the cage type rotating cylinder body 10 similarly to the first invention as shown in FIG. 3 and FIG, 4, and according to this, it i possible to increase the flue-gas treatment ability more than the first invention.

### THE OTHER WORKING EXAMPLE

Furthermore, in the case of constituting a limestone-gypsum method flue-gas desulfurization apparatus comprising by that the fillers for flue-gas treatment 11 or the fillers for flue-gas treatment 11a according to the above second invention that comprises by providing windows 2 with hole diameter of one third to two thirds of diameter of thin-walled cylinder body (thickness is less than 3 mm) on a cylinder wall of the thin-wailed cylinder body thickness is less than 3 mm) 1 with length substantially equal to the diameter thereof in a circumferential direction of the thin-walled cylinder body (thickness is less than 3 mm) in the gas horizontal flow system of the rotating treatment device is formed, and carbon dioxide gas absorption apparatus comprising by that the fillers for flue-gas treatment 11 or the fillers for flue-gas treatment 11a according to the above second invention that comprises by providing windows 2 with hole diameter of one third to two thirds of diameter of thin-walled cylinder body on a cylinder wall of the thin-walled cylinder body (thickness is less than 3 mm) 1 with length substantially equal to the diameter thereof in a circumferential direction of the thin-walled cylinder body (thickness is less than 3 mm) in the gas horizontal flow system of the rotating treatment device is formed in series, flue-gas desulfurization and carbon dioxide gas absorption can be worked simultaneously and more efficient flue-gas treatment can be worked.

What is claimed is:

1. Fillers for flue-gas treatment comprising by preparing two kinds of large and small fillers with different diameters of cylinder bodies each of which comprising by plurally providing circular windows having hole diameter from one third to two thirds of diameter of a thin-walled cylinder body on a cylinder wall of the thin-walled cylinder body that the diameter and the length thereof are approximately equal in a circumferential direction of the thin-walled cylinder body, wherein the smaller filler (hereinafter, saying “the small filler”) is installed in an inner diameter side of the larger filler (hereinafter, saying “the large filler”), and the small filler is supported loosely in a suspended state to the cylinder body of the large filler by a suspending retainer, so that the small filler is constituted movably along an inner surface of the cylinder body of the large filler.

2. A limestone-gypsum method flue-gas desulfurization apparatus comprising by plurally filling fillers for flue-gas treatment described in claim 1 in a gas horizontal flow system of a rotating treatment device.

3. A carbon dioxide absorption apparatus by filling fillers for flue-gas treatment described in claim 1 and making gas flow direction horizontally.

4. A flue-gas desulfurization and carbon dioxide absorption apparatus characterized in that a limestone-gypsum method flue-gas desulfurization apparatus comprising by that the fillers for flue-gas treatment described in claim 1 are plurally filled in a gas horizontal flow system of a rotating treatment device is formed, and following this, a carbon dioxide absorption apparatus comprising by plurally filling the fillers for flue-gas treatment described in claim 1 is provided in series.
